(19) United States
(12) Patent Application Publication
(10) Pub. No.: US 2018/0128043 A1
(43) Pub. Date: May 10, 2018

(54) Intelligent pet door

(71) Applicant: Yu-Chen Liu, Shenzhen (CN)

(72) Inventor: Yu-Chen Liu, Shenzhen (CN)

(21) Appl. No.: 15/866,598

(22) Filed: Jan. 10, 2018

(30) Foreign Application Priority Data
Oct. 24, 2017 (CN) 201721377593.9

(51) Int. Cl. E06B 7/32; A01K 29/00

(52) U.S. Cl. CPC E06B 7/32; G08B 1/08; A01K 29/005

(57) ABSTRACT

An intelligent pet door includes a door frame and a movable door located in the door frame, wherein an inductive magnet is fixed to the movable door, and a PCBA is fixed to the door frame and comprises a magnetic inductive switch, an MCU, a voice playing module, a loudspeaker, keys and a data sending and receiving module; when the movable door is opened, the magnetic inductive switch is inductively triggered by the magnet and outputs a trigger signal to the MCU, the MCU outputs a control signal to the voice playing module after recognizing the trigger signal, and the voice playing module promotes the loudspeaker to play corresponding music. The intelligent pet door can intelligently remind the owner by automatically sensing the in-out condition of a pet and playing sounds and can sense the activity condition and the health condition of the pet through the IOT technique.

### BACKGROUND OF THE INVENTION

### Technical Field

The invention relates to the technical field of pet supplies, in particular, to a pet door.

### Description of Related Art

Pet door products on the present market are simply mechanical structures, have the only function of allowing pets to come in or go out and cannot send any prompt information about the in-out conditions of the pets to the owners, consequentially, the owners have to check on the spot to obtain the specific conditions of the pets, and great inconvenience is caused to the owners.

### BRIEF SUMMARY OF THE INVENTION

To overcome the defects that in the prior art, a pet door has only one function and cannot remind the owner when a pet comes in or goes out, the invention provides a pet door with an intelligent prompt function.

According to the technical scheme adopted by the invention for solving technical problems: an intelligent pet door is provided and comprises a door frame and a movable door located in the door frame, wherein a magnet is fixed to the movable door, a PCBA is fixed to the door frame and comprises a magnetic inductive switch, an MCU, a voice playing module, a loudspeaker, keys and a data sending and receiving module; when the movable door is opened, the magnetic inductive switch is inductively triggered by the magnet and outputs a trigger signal to the MCU, the MCU outputs a control signal to the voice playing module after recognizing the trigger signal, and the voice playing module promotes the loudspeaker to play corresponding music.

According to the intelligent pet door of the invention, the PCBA further comprises the data sending and receiving module which is used for sending corresponding signals to a terminal such as a mobile phone, and a cloud server.

According to the intelligent pet door of the invention, the data sending and receiving module transmits corresponding signals through Bluetooth, WIFI, Zigbee, GPRS and the like.

According to the intelligent pet door of the invention, the keys include a volume on/off switch, a volume adjustment key and a pet door in-out direction adjustment key.

According to the intelligent pet door of the invention, the volume on/off, the volume size, pet in-out prompt sounds and the in-out direction of the pet door can be set through APPs on the terminal and the cloud server.

In the invention, the magnet and the PCBA are organically combined with the mechanical structure of the pet door, and thus the function of reminding the owner with different types of music when a pet comes in or goes out through the pet door is achieved; data are sent to the terminal device such as a mobile phone, and the cloud server through the data sending and receiving module of an IOT-type device such as Bluetooth, WIFI, Zigbee and GPRS, and after the corresponding data are processed through APP software on the terminal and the cloud server, the owner can conveniently check the activity condition of the pet so as to judge the health condition of the pet; the volume size, on/off of sounds, different prompt sounds played when the pet comes in or goes out, and the in-out direction of the pet door can be set through the terminal device and the cloud server. Compared with an existing pet door only having the in-out function, through the intelligent pet door of the invention, the owner can know the activity condition of the pet at any time and can check the activity characteristics and living habits of the pet through a mobile phone or a cloud server, and the convenience is greatly improved.

### BRIEF DESCRIPTION OF THE SEVERAL VIEWS OF THE DRAWINGS

A further description of the invention is given with the accompanying drawings and embodiments as follows, in the drawings:

FIG. 1 is a structural diagram of an intelligent pet door of the invention; and

FIG. 2 is a functional block diagram of a circuit of the intelligent pet door of the invention.

### DETAILED DESCRIPTION OF THE INVENTION

For a better understanding of the purposes, technical schemes and advantages of the invention, a further detailed description of the invention is given with accompanying drawings and embodiments as follows. It should be understood that the specific embodiment in the following description is only used for explaining the invention instead of being used for limiting the invention.

### Abbreviations and Definition of Key Terms

Internet of things is abbreviated to IOT.

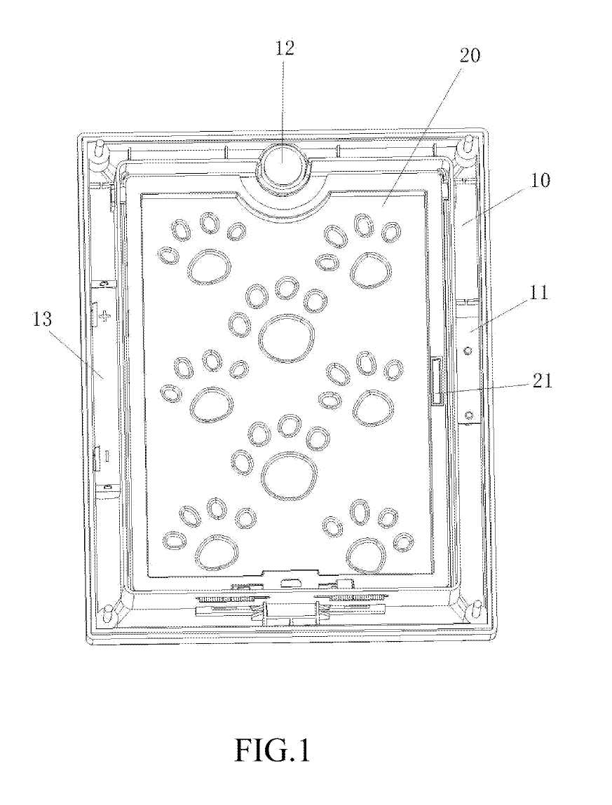

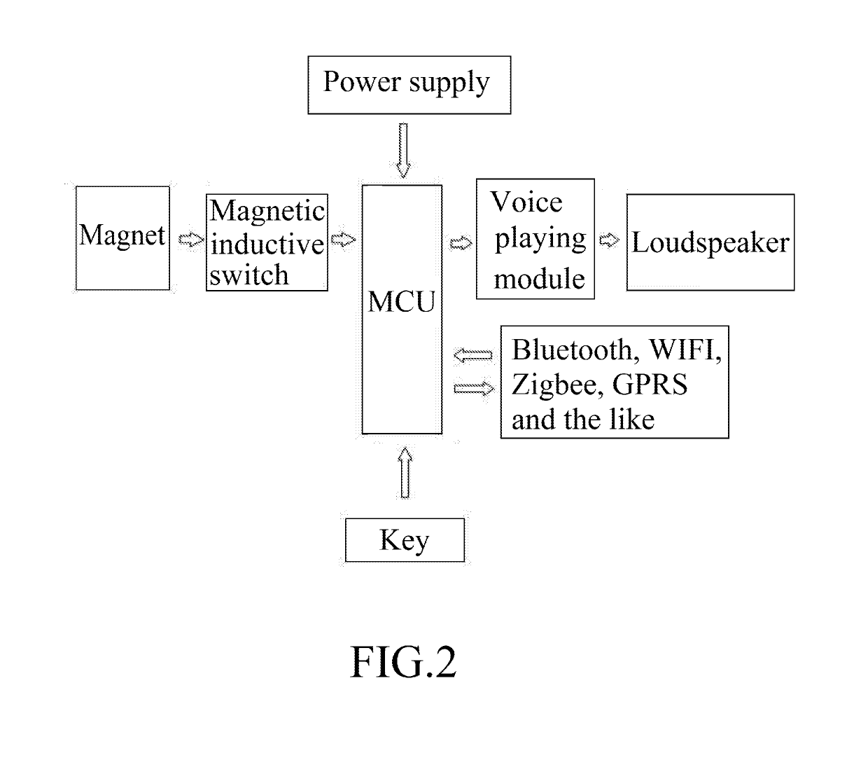

As is shown in FIG. 1 and FIG. 2, an intelligent pet door provided by the invention comprises a door frame 10 and a movable door 20 located in the door frame 10, wherein the movable door 20 can rotate around the door frame 10, a trigger magnet 21 is fixed to the movable door 20, a PCBA 11 is fixed to the door frame 10 and comprises a magnetic inductive switch, a MCU, a voice playing module, a loudspeaker 12, keys and a data sending and receiving module, and a power supply 13 is used for supplying currents to the whole module; when a pet comes in or goes out through the pet door, the movable door 20 in the middle can be opened and closed; when the movable door 20 is opened, the magnetic inductive switch is inductively triggered by the magnet 21 fixed to the movable door 20 and outputs a trigger signal to the MCU, the MCU outputs a control signal to the voice playing module after recognizing the trigger signal, the voice playing module promotes the loudspeaker to play corresponding music, and thus the owner is reminded of the in-out condition of the pet through music sounds; compared with the existing pet door having the defect that the owner cannot learn about the activity condition of the pet, the intelligent pet door enables the owner to know the in-out activity condition of the pet at any time through sound (or music) prompt.

Furthermore, the PCBA comprises the data sending and receiving module, and the IOT-type data sending and receiving module sends corresponding signals to a terminal such as a mobile phone, and a cloud server. Specifically, an induction signal generated when the pet comes in or goes out through the pet door is sent to the MCU after being triggered through an inductor, the MCU processes the induction signal and then wirelessly sends the induction signal to a device terminal such as a mobile phone, a PAD and a computer, and a cloud server through a Bluetooth module or a WIFI module or a Zigbee module or a GPRS module or other modules, and thus the owner can learn about the time and frequency of in-out activities of the pet quite conveniently through the device terminal such as the mobile phone, the PAD and the computer. A tendency chart about the in-out time points and the outdoor activity durations of the pet can be generated after data sent from the MCU are processed by the cloud server through cloud computation, and the customer can learn about the activity rule of the pet conveniently through big data on the cloud server and accordingly can judge the health condition of the pet.

Furthermore, the keys include a volume on/off key, a volume adjustment key and a pet door in-out direction adjustment key. Specifically, when the size of output volume is adjusted through the volume adjustment key on the PCBA, the volume is adjusted by one stage every time the volume adjustment key is pressed for a short time, the volume is adjusted to the next stage after the volume adjustment key is pressed for a short time again, and the operation is performed repeatedly. Music prompt sounds can be played every time the volume is switched by one stage. The music prompt function of the pet door can be disabled or enabled through long-time pressing of the volume adjustment key, and music prompt sounds can be played every time the function is switched.

Furthermore, the volume on/off, the volume size, pet in-out prompt sounds and the in-out direction of the pet door can be set through APPs of the terminal and the cloud server. The owner can set and check the prompt function of the pet door through the terminal device such as the mobile phone, the PAD and the computer via Bluetooth or WIFI or Zigbee or GPRS, and thus the in-out condition of the pet is checked. The volume size and the volume on/off can be set quite conveniently through a setting button by means of the APP on the terminal device, different sounds can be set according to the fact whether the pet comes in or goes out, and thus the owner can judge whether the pet comes in or goes out according to different sounds heard by the owner.

The intelligent pet door of the invention organically integrates the electronic function and the structure, thereby having the following effects that firstly, the music prompt function is achieved when the pet comes in or goes out through the pet door; secondly, the pet door is combined with the IOT-type device such as Bluetooth, WIFI, Zigbee and GPRS, so that intelligent control is achieved; thirdly, on/off of sounds (or music) can be controlled through the keys arranged on the pet door; fourthly, the volume size can be adjusted through APP software on the device terminal such as the mobile phone via the network; fifthly, the in-out condition of the pet is induced through the magnetic inductive switch, and sounds (music) played when the pet comes in and sounds (or music) played when the pet goes out can be set independently so that the owner can easily know whether the pet comes in or goes out; sixthly, the in-out condition data of the pet are transmitted to the cloud server through an IOT-type data communication method such as Bluetooth, WIFI, Zigbee and GPRS, and the owner can learn about the living habits and the health condition of the pet through cloud computation and analysis by the cloud server.

Although the invention is disclosed through the above embodiment, the protection scope of the invention is not limited to the above embodiment at all, and transformations and substitutes of the above components made without deviating from the concept of the invention are all within the claim scope of the invention.

What is claimed is:

1. An intelligent pet door, comprising a door frame and a movable door located in the door frame; characterized in that a magnet is fixed to the movable door, a PCBA is fixed to the door frame and comprises a magnetic inductive switch, an MCU, a voice playing module, a loudspeaker, keys and a data sending and receiving module; when the movable door is opened, the magnetic inductive switch is inductively triggered by the magnet and outputs a trigger signal to the MCU, the MCU outputs a control signal to the voice playing module after recognizing the trigger signal, the voice playing module promotes the loudspeaker to play corresponding music, and the activity condition and the health condition of a pet are sensed through the TOT technique.

2. The intelligent pet door according to claim 1, characterized in that the PCBA further comprises the data sending and receiving module which is used for sending corresponding signals to a terminal such as a mobile phone, and a cloud server.

3. The intelligent pet door according to claim 2, characterized in that the data sending and receiving module transmits corresponding signals through Bluetooth, WIFI, Zigbee, GPRS and the like.

4. The intelligent pet door according to claim 1, characterized in that the keys include a volume on/off key, a volume adjustment key and a pet door in-out direction adjustment key.

5. The intelligent pet door according to claim 2, characterized in that the volume on/off, the volume size, pet in-out prompt sounds and the in-out direction of the pet door can be set through APPs on the terminal and the cloud server.
